(19) United States
(12) Patent Application Publication
(10) Pub. No.: US 2008/0286471 A1
(43) Pub. Date: Nov. 20, 2008

(54) PROTECTIVE GEL FOR AN ELECTRICAL CONNECTION

(76) Inventor: Marc D. Doubleday, Cary, IL (US)

Correspondence Address: MATHEW R. P. PERRONE, JR., 210 SOUTH MAIN STREET, ALGONGUIN, IL, 60102-2639, US

(21) Appl. No.: 11/750,427

(22) Filed: May 18, 2007

(51) Int. Cl. B05D 3/10; C09K 15/02; C09K 15/04

(52) U.S. Cl. 427/337; 106/14.05; 106/14.11; 106/14.21; 106/14.39; 106/14.41

(57) ABSTRACT

An electrical connection for a trailer hitch on a vehicle joins a trailer electrical connection. These electrical connectors join together to carry the power to illuminate the trailer lights on the trailer and carry out other functions. Both connections are protected by a protective gel for the electrical connections having a thickening agent, a cleaning agent, a chelating agent, a reducing agent, anti-corrosive agent, a buffer, and an antifreeze agent.

This invention relates to a protective gel and more particularly to a protective gel for an electrical connection, especially suitable for use in assisting the functioning of the electrical connection between a vehicle and a trailer.

### BACKGROUND OF THE INVENTION

Quite commonly, a person will have a trailer hitch on a vehicle. By that trailer hitch is a vehicle electrical connection. On the trailer is a trailer electrical connection. These electrical connectors join together to carry the power to illuminate the trailer lights, charge auxiliary batteries, activate braking systems, and carry out other important functions. Commonly, these connectors each have one or more electrically conductive male pin terminals and one or more electrically conductive socket terminals which receive the complementally formed, female and male electrically conductive terminals on the other connector, thus, forming a low resistance path for electrical current flow.

Once mated, pin and socket terminals are typically characterized by point contacts which are very small in area, both individually and collectively. The voids between these point contacts do not normally contribute to electrical flow. When the vehicle electrical connection is joined to the trailer electrical connection and the trailer is attached to the vehicle, lights and other electrical components desirably work on the trailer.

A major problem with the electrical connection, is due to the exposure of such a trailer electrical connection or connector to the environmental elements. Because of this exposure the male and female electrical terminals often become covered in dirt or corrosion that will prevent a satisfactory electrical contact between the male and female electrical connectors. In this situation, proper electrical contact is prevented and the trailer lights may not work. A trailer, or any vehicle, on a road without properly functioning lights can be dangerous. This danger occurs whether the trailer is towed by the vehicle in daylight or in darkness. Greater danger exists of course in darkness. This is particularly frustrating to the user.

Many methods that have been utilized in an attempt to remedy this problem are known. Sometimes a protective cover is placed over the vehicle electrical connection as well as the trailer electrical connection. This cover does not always protect the connection. Sometimes moisture is trapped inside the cover and corrosion occurs. Sometimes the cover leaks air and water. In either case, the resulting corrosion prohibits the trailer connection to the vehicle from working. Perhaps more importantly, these covers fail to clean and restore the already dirty and corroded connections or connectors, and do not aid in the electrical connectivity thereof.

In order to overcome some of the problems associated with a cover, cleaning tools are known. All such tools scrape corrosion from the connection in order to permit a clearer and power transmitting electrical connection. It is very difficult to remove all of the corrosion, grease and road grime while leaving the electrical connection in operating order. During the corrosion removal, it is quite possible to damage the connector itself. Also, none of these cleaning tools provide protection to prevent additional corrosion.

Still, another manner of protecting electrical connection is to coat the connectors prior to mating with a dielectric grease in an attempt to minimize environmental exposure and subsequent corrosion. While these greases showwide utility in semipermanent electrical connections such as automotive battery terminals or spark plug's connectors, they pose several problems when used with trailer lighting connections. The application of a grease does not facilitate the cleaning of already corroded terminals and being inherently non-conductive in nature, such grease can itself interfere with the electrical connection and prohibit the trailer lights from working.

Furthermore, grease remaining on the electrical connector after disconnection can accumulate road grime and other contaminants promoting corrosion to parts of the terminals exposed by the rubbing action of mating and unmating the connectors. Being thick and non-flowing, application of greases onto the connector terminals or into the sockets can be a difficult and messy affair that is frustrating to the user. An electrically conductive grease or gel can be derived from at least one base oil, such as mineral oil with silica or silicate additives to impart corrosion resistance and metal or graphite flakes to impart electrical conductance. Such a grease has a high dropping point (approximately 250° C.) below which it remains non-fluid.

There are several problems associated with this potential remedy. The inventive grease fails to clean or restore already corroded terminals and because it is non-flowing at ambient temperatures, application remains a messy and frustrating experience. The grease, being constructed of a hydrophobic, oil derived base, is not easily removed and will remain on the connectors after disconnection and accumulate road grime and contaminates, leading to corrosion of non-protected areas. Additionally, and perhaps more importantly, the high conductivity imparted by inclusion of graphite or metal flakes can result in short circuits between adjacent electrical terminals resulting in false lighting signals; which is a dangerous situation.

Using a hydrophilic, paste like preparation to be applied at the interface of an electrical connection to help insure the long term integrity of electrical connections subject to high current flows, such as automobile battery terminal also fails. Like the corrosion resistant lubricants and greases described, there are several shortcomings with this potential remedy. The paste fails to clean or restore already corroded terminals and because it is non-flowing at ambient temperatures. Application is also a messy and frustrating experience. The paste; being partially composed of water insoluble materials such as fused silica, fine sand, graphite powder or metal flakes; is not easily removed and will remain on the connectors after disconnection and accumulate road grime and contaminates, leading to corrosion of non-protected areas. Additionally, and perhaps more importantly, the high conductivity imparted by inclusion of graphite or metal flakes can result in short circuits between adjacent electrical terminals resulting in false lighting signals; a dangerous situation.

Clearly, it is highly desirable to protect an electrical connector while minimizing the problems above described. If the electrical connector can be protected, while maintaining its electrically conductive integrity, great advantages are obtained. If the protection mechanism cleans and restores already corroded electrical connectors or facilitates the electrical connection, even greater advantages are available.

### SUMMARY OF THE INVENTION

Among the many objectives of the present invention is the provision of a protective gel for an electrical connection, which is easy for the user to apply at ambient temperatures and is able to stay in the area in which it is applied.

Another objective of the present invention is the provision of a protective gel for an electrical connection, which facilitates electrical flow through the mated connectors.

Still another objective of the present invention is the provision of a protective gel for an electrical connection, which can clean dirt and other undesirable elements from the electrical connectors.

Also, an objective of the present invention is the provision of a protective gel for an electrical connection, which has a buffer, a chelating agent and a chemically reducing agent to restore corroded electrical connectors.

A still further objective of the present invention is a protective gel for an electrical connection, which has a chemically reducing, anti-corrosive substance to prevent corrosion on the electrical connectors.

Another objective of the present invention is a protective gel for an electrical connection, which is water soluble so that it is easily cleaned and removed from the electrical connection.

These and other objectives of the invention (which other objectives become clear by consideration of the specification, claims and drawings as a whole) are met by providing a protective gel for an electrical connector, which is water soluble; and has a thickening agent, a cleaning agent, a chelating agent, a reducing, anti-corrosive agent, a buffer, and an antifreeze agent.

### DESCRIPTION OF THE PREFERRED EMBODIMENTS

The subject of the current invention solves a variety of problems associated with the electrical connector on a trailer adapted to connect the trailer to the electrical on a towing vehicle. The protective gel of the present invention has a thickening agent so it stays on the electrical connectors, has limited electrical conductivity due to its aqueous nature and dissolved salts, has a cleaning agent to remove dirt and grease, a chelating agent and an anti-corrosive agent (a chemical reducing agent) to restore and further prevent corrosion, a buffer to maintain a reasonably stable pH, and an antifreeze agent to allow application at sub freezing temperatures. This protective gel is completely water soluble so that it can be easily washed off the electrical connectors when desired.

In the preferred embodiments as described below, the preferred agent is described, and then it is followed by the alternative agents. One or more alternative agents can be substituted in part or in whole for the preferred agent in each category. Unless otherwise specified, all percentages are by weight.

The protective gel of the current invention has a thickening agent so that it stays on the area of the electrical connectors where it is applied, thus maximizing the potential benefit. The selection and use of the thickening agent and the resulting viscous properties of the composition are quite important. First, the viscosity must be sufficiently high to prevent free flowing from the terminals or sockets, thus assuring the proper application of the invention to the surfaces of interest prior to mating the connectors. Second, to aid in application, the viscosity must be sufficiently low to allow dispensing using a flexible metal or plastic tube fitted with a dropper nozzle. Lastly, some thickening agents tend to “string” or form lengths of material being sprayed at the nozzle with higher concentrations and viscosities. Care must be taken to minimize this property to facilitate both 10 filling of the dispensing tube as well as application onto the electrical terminals. The preferred thickening agent is carboxymethylcellulose. It is desirable that the carboxymethylcellulose be about 0.5 to about 5 percent of the composition. More preferably, it is desirable that the carboxymethylcellulose be about 0.5 to about 3 percent of the composition. Most preferably, it is desirable that the carboxymethylcellulose be about 0.5 to about 1 percent of the composition.

While carboxymethylcellulose is the preferred thickening agent a variety of alternatives can be utilized, singly or in combination. These alternatives include carbomer, methylcellulose, hydroxyethylcellulose, hydroxypropylcellulose, guar gum, alginate, pectin, gelatin, xanthangum, and polyvinylalcohol. It is desirable that one of these alternatives be up to about 8 percent of the composition. More preferably, it is desirable that one of these alternatives be about 0.5 to about 6 percent of the composition. Most preferably, it is desirable that one of these alternatives be about 1 to about 5 percent of the composition.

Additionally, the gel properties of the thickening agent may be further modified such as with the addition of polyvalent cations as is known in the art (Aqualon® Physical and Chemical Properties, Hercules Incorporated, Wilmington, Del.).

In order to facilitate electrical flow through the contact voids that are filled with the gel, the gel must have an appropriate conductivity. This conductivity must be limited to avoid electrical flow between adjacent terminals resulting in a short circuit and false lighting signals as a result of over application of the gel. Conductivity, or conversely, the resistance of gel compositions can be measured with an electrical resistance meter (such as Model 452.520600 Multi-meter, Sears Holdings, Hoffman Estates, Ill.) by immersing the probes into the gel approximately one centimeter apart and measuring the resistance. Preferably, the resistance of the gel is between 1000 and 300,000 ohms. More preferably, the resistance is between 1000 and 50,000 ohms. Most preferably, the resistance is between 1000 and 20,000 ohms. This resistance can be varied by adjusting the composition of the gel as demonstrated in the examples.

In order to clean the electrical connectors, a cleaning agent is used. The preferred cleaning agent is the ionic surfactant, sodium laurylsulfate. It is desirable that the sodium laurylsulfate be about 0.5 to about 25 percent of the composition. More preferably, it is desirable that the sodium laurylsulfate be about 0.5 to about 3 percent of the composition. Most preferably, it is desirable that the sodium laurylsulfate be about 0.5 to about 1 percent of the composition.

While sodium laurylsulfate is the preferred cleaning agent, other alternatives including both ionic and non-ionic surfactants can be utilized. These alternatives include ionic surfactants such as sodium laurethsulfate and sodium dodecylbenzenesulphonate. Usefulnon-ionicsurfactantsinclude polysorbate 20, and polysorbate 80. Additionally, commercial detergent concentrates such as All® or Small & Mighty™ (Unilever NV, Netherlands) may be used as the cleaning agent. It is desirable that one of these alternatives be 0 to about 20 percent of the composition, singly or in combination. More preferably, it is desirable that one of these alternatives be about 0.5 to about 15 percent of the composition. Most preferably, it is desirable that one of these alternatives be about 1 to about 10 percent of the composition.

In order to restore corroded terminals, a chelating agent is used in combination with a chemically reducing agent, which acts as an anti-corrosion agent. While it is not desired to bound a particular theory, it is believed that, in concert, these compounds form an electrochemical system that can sequester metal ions from corrosion products and electrolessly deposit them on the terminal surface, thereby restoring the corroded metal. It is well known that metal cations are formed as a result of corrosion by loss of electrons. That metal cation can be sequestered from the generally insoluble corrosion byproduct salt with the use of an appropriate chelating agent. Once solublized by the chelating agent, a suitable chemically reducing agent (that is an electron donor) can reduce the metal cation back to its natural metallic state. This process of deposition is well known in the electroless metal plating art. The restorative capability of these compositions can be demonstrated on suitably prepared corroded metal coupons.

For example, a copper sheet (such Part Number 8963K36, McMaster Carr, Elmhurst, Ill.) is cut into 0.7 to two centimeters (0.5 inch by 2 inches) sections and the surface of the sections prepared by abrasion with 220 grit sandpaper to remove any protective coatings. The bottom one third of the coupons is placed into a solution of 0.5% sodium chloride and 0.1% hydrochloric acid in distilled water. As the solution evaporates, a green corrosion product is deposited onto the bottom third of the coupon. These corroded coupons are then exposed to the gel compositions to demonstrate restoration of the corroded product back to metal, evidenced by disappearance of the green corrosion product and return to a bright metal surface.

The preferred chelating agent is sodium citrate. It is desirable that the sodium citrate be about 0.5 to about 6 percent of the composition. More preferably, it is desirable that the sodium citrate be about 0.5 to about 4 percent of the composition. Most preferably it is desirable that the sodium citrate be about 1 to about 2 percent of the composition.

While sodium citrate is the preferred chelating agent, other alternatives or combinations thereof may be utilized. These alternatives include metal chelating agents such as tartrate, propionate, amino substituted carboxylic acids such as ethylenediamine tetraacetic acid (EDTA), and Quadrol® (BASF Corporation, Mt. Olive, N.J.). The acids themselves may be used as well as the metallic salts.

It is desirable that one or more of these alternative chelating agents be 0 to about 8 percent of the composition. More preferably, it is desirable that one of these alternatives be about 0.5 to about 6 percent of the composition. Most preferably, it is desirable that one of these alternatives be about 1 to about 5 percent of the composition.

The preferred chemically reducing agent is sodium sulfite. It is desirable that the sodium sulfite be about 0.5 to about 8 percent of the composition. More preferably, it is desirable that the sodium sulfite be about one to about six percent of the composition. Most preferably, it is desirable that the sodium sulfite be about two to about four percent of the composition.

While sodium sulfite is the preferred chemically reducing agent, other alternatives or combinations thereof can be utilized. These alternatives include other inorganic reducing agents such as other sulfites, phosphites, hypophosphites, borohydrides, and organic reducing agents such as aminoboranes, and formaldehyde. It is desirable that one of these alternatives be 0 to about 20 percent of the composition. More preferably, it is desirable that one of these alternatives be about 0.5 to about 15 percent of the composition. Most preferably, it is desirable that one of these alternatives be about 0.5 to about five percent of the composition.

In order to prevent corrosion on the electrical connectors, an anti-corrosive agent is used. The anticorrosive compound must be a sacrificial electron donor to prevent oxidation of the metal terminals. These compounds are well known in the art. The preferred anti-corrosive agent is sodium sulfite. It is desirable that the sodium sulfite be about 0.5 to about 8 percent of the composition. More preferably, it is desirable that the sodium sulfite be about one to about six percent of the composition. Most preferably, it is desirable that the sodium sulfite be about two to about four percent of the composition.

While sodium sulfite is the preferred anti-corrosive agent, other alternatives or combinations thereof can be utilized. These alternatives include other sulfites, phosphites, hypophosphites, borohydrides, aminoboranes, and formaldehyde. It is desirable that one of these alternatives be 0 to about 20 percent of the composition. More preferably, it is desirable that one of these alternatives be about 0.5 to about 15 percent of the composition. Most preferably, it is desirable that one of these alternatives be about 0.5 to about ten percent of the composition.

In order to buffer the electrical connectors and prevent wide pH swings in them, a buffering agent is used. The buffering agent preferably maintains the pH in a range of 5-10 pH units or more preferably in the range of 6-9 pH units. To increase the effectiveness of the buffer, its acid/base disassociation constant (pKa) is near the desired range. The preferred buffer is sodium bicarbonate (pKa=6.37). It is desirable that the sodium bicarbonate be about 0.5 to about five percent of the composition. More, preferably, it is desirable that the sodium bicarbonate be about 0.5 to about three percent of the composition. Most preferably, it is desirable that the sodium bicarbonate be about 0.5 to about one percent of the composition.

While sodium bicarbonate is the preferred buffer, other alternatives may be utilized, singly or in combination. These alternatives include other carbonates, phosphates, and amines. It is desirable that one or more of these alternatives be zero to about 20 percent of the composition. More preferably, it is desirable that one of these alternatives be about 0.5 to about 15 percent of the composition. Most preferably, it is desirable that one of these alternatives be about one to about five percent of the composition.

In order to allow application at sub-freezing temperatures and prevent the electrical connectors from freezing or freezing together, an antifreeze agent is added to the protective gel. The preferred antifreeze agent is glycerin. It is desirable that the glycerin be about 30 to about 70 percent of the composition. More preferably, it is desirable that the glycerin be about 30 to about 60 percent of the composition. Most preferably, it is desirable that the glycerin be about 40 to about 50 percent of the composition.

While glycerin is the preferred antifreeze agent, other alternatives can be utilized, singly or in combination. These alternatives include propylene glycol and ethylene glycol. It is desirable that one or more of these alternatives be about 20 to about 80 percent of the composition. More preferably, it is desirable that one of these alternatives be about 25 to about 75 percent of the composition. Most preferably, it is desirable that one of these alternatives be about 30 to about 70 percent of the composition.

An optional addition to the protective gel is a pH indicator such as Phenol Red or Bromothymol Blue. Either of these additions can act as strength indicators. Phenol Red with change from red to yellow when the chemically reducing, anti corrosive material is consumed and the pH falls. Bromothymol Blue changes from blue to yellow as the chemically reducing, anti corrosive material is consumed and the pH falls. Either of these additions can be added up to 0.5 percent of the composition. Any greater addition than 0.5 percent is plausible but unnecessary.

Another optional addition to the protective gel is an antimicrobial preservative. It is important to preserve the solutions as soon as possible after preparation to prevent microbial action and generation of enzymes, such as cellulases, that may affect gel stability on storage. Useful preservatives include sodium benzoate, sodium propionate, sodium or potassium sorbate, methyl or propyl paraben, Dowicide A (Dow Chemical, Midland Mich.) and Proxel GXL (Avecia, Wilmington Del.). Any of these additions can be added up to 0.5 percent of the composition. Any greater addition than 0.5 percent is plausible but unnecessary.

In following examples, which illustrate without unduly limiting the invention, all parts and percentages are by weight unless otherwise specified.

### EXAMPLE ONE

A dielectric connector grease (Versachem, ITW Poly Mex, S.A. de C.V.) is purchased. The grease is applied to corroded connectors on both the trailer and tow vehicle. The connectors are mated and the trailer electrical system fails to work properly. Several repeated attempts at mating are required to achieve an adequate connection and properly functioning electrical systems. This is particularly frustrating. After use the connectors are unmated. The terminals remain corroded and are covered with a sticky grease. It is necessary to remove the grease to prevent accumulation of dirt and road grime. This is particularly difficult and requires several meticulous wipings. In laboratory tests, application of the dielectric grease fails to restore corroded metal coupons as described and has a resistance greater than 500,000 ohms.

### EXAMPLE TWO

A protective gel of the following composition is provided:

| Component | Approximate Percent by Weight |
|---|---|
| Carboxymethylcellulose | 2.1 |
| Sodium Laurylsulfate | 2.1 |
| Citrate (as Citric Acid) | 3.2 |
| Sodium Sulfite | 3.2 |
| Propylene Glycol | 53 |
| Sodium Hydroxide | 1.6 |
| Phenol Red | 0.0027 |
| Potassium Sorbate | 0.27 |
| Distilled Water | 34.3 |

This composition is prepared as follows: Two grams of carboxymethylcellulose (CMC) (12M31P, Hercules Incorporated, Wilmington Del.) is mixed with 50 grams propylene glycol. It is important to note that the CMC is generally be mixed with the antifreeze agent first as this facilitates hydration of the cellulose gum upon addition of water.

Thirty-two grams of distilled water are added and mixed at which point the composition begins to thicken. Three grams of citric acid, three grams of sodium sulfite and 0.25 grams of potassium sorbate are mixed and added to the thickening composition, and then mixed thoroughly and vigorously to facilitate hydration of the cellulose gum. It is important to note that both citrate (pKa=6.4) and sulfite (pKa=6.91) can act as desirable pH buffers in this system.

The agitation is moderated and two grams of sodium laurylsulfate are added along with 0.0025 grams of phenol red (as 0.25 ml of 1% phenol red in distilled water). It is important the agitation be slowed and controlled when the surfactant is added to prevent foaming in the gel which is quite persistent and troublesome. The pH of the resulting composition is adjusted with 1.5 grams of sodium hydroxide to a pH of approximately 8 causing the phenol red to change in color from yellow to light red. The resulting gel is quite thick and will flow very slowly. It exhibits some stringiness, but not so much to impede efficient application from a dispensing tube with a dropper tip.

This composition is shown to restore corroded copper connectors as described previously and the resistance is measured at 12,000 ohms. When applied to the connectors of electrical connections for a trailer and a vehicle to be electrically connected, the electrical connection works efficiently. Once disconnected, residual protective gel can be easily removed by rinsing with water if desired.

### EXAMPLE THREE

A protective gel of the following composition is provided:

| Component | Approximate Percent by Weight |
|---|---|
| Carboxymethylcellulose | 0.95 |
| Sodium Laurylsulfate | 0.95 |
| Citrate (as Citric Acid) | 0.95 |
| Sodium Phosphite | 0.95 |
| Glycerin | 47.5 |
| Triethanol Amine | 4.75 |
| Bromothymol Blue | 0.0027 |
| Potassium Sorbate | 0.09 |
| Distilled Water | 43.9 |

This composition is prepared as follows: One gram of CMC (12M31P, Hercules Incorporated, Wilmington Del.) is mixed with 50 grams glycerin. It is important to note that the CMC must generally be mixed with the antifreeze agent first as this facilitates hydration of the cellulose gum upon addition of water.

Forty-six grams of distilled water are added and mixed at which point the composition begins to thicken slightly. One gram of citric acid, one gram of sodium phosphite and 0.1 grams of potassium sorbate are mixed and added to the thickening composition, and then mixed thoroughly and vigorously to facilitate hydration of the cellulose gum. It is important to note that citrate (pKa=6.4) can act as desirable pH buffer in this system. The agitation is moderated and one gram of sodium laurylsulfate are added along with 0.0025 grams of bromothymol blue (as 0.25 ml of 1% bromothymol blue in distilled water). It is important the agitation be slowed and controlled when the surfactant is added to prevent foaming in the gel which is quite persistent and troublesome.

The pH of the resulting composition is adjusted with five grams of triethanol amine to a pH of approximately 7.5 causing the bromothymol blue to change in color from yellow to light blue. The resulting gel is viscous and will flow slowly but readily and is easily applied from a dispensing tube with a dropper tip without stringing. This composition is thus shown to restore corroded copper coupons as described previously and the resistance is measured at 20,000 ohms. When applied to the electrical connections for a trailer and a vehicle, the electrical connection works efficiently. Once disconnected, residual protective gel can be easily removed by rinsing with water if desired. However, the increased viscosity of example two makes it preferred.

### EXAMPLE FOUR

A protective gel of the following composition is provided:

| Component | Approximate Percent by Weight |
|---|---|
| Carbomer | 0.89 |
| Polysorbate 20 | 4.7 |
| Citrate (as Citric Acid) | 0.22 |
| Sodium Sulfite | 0.22 |
| Propylene Glycol | 35.8 |
| Triethanol Amine | 10.7 |
| Bromothymol Blue | 0.0022 |
| Potassium Sorbate | 0.09 |
| Distilled Water | 47.61 |

This composition is prepared as follows: Forty (40) grams propylene glycol is mixed with 53 grams of distilled water, 0.25 grams of citric acid, 0.25 grams of sodium sulfite and 0.1 grams of potassium sorbate. To this well mixed composition, one gram of Carbomer 940 (Snowdrift Farms, Tucson Ariz.) is added and then mixed thoroughly and vigorously to facilitate hydration of the carbomer. Care must be taken to add the carbomer after citric acid, sodium sulfite and potassium sorbate are added and thoroughly mixed. Addition of these agents after the carbomer may cause the gel to collapse.

It is important to note that both citrate (pKa=6.4) and sulfite (pKa=6.91) can act as desirable pH buffers in this system. The agitation is moderated and five grams of polysorbate 20 are added along with 0.0025 grams of bromothymol blue (as 0.25 ml of 1% bromothymol blue in distilled water). It is important the agitation be slowed and controlled when the surfactant is added to prevent foaming in the gel which is quite persistant and troublesome. The pH of the resulting composition is adjusted with 12 grams of triethanol amine to a pH of approximately 7.5 causing the bromothymol blue to change in color from yellow to light blue.

The resulting gel is quite thick and firm and non-flowing. It exhibits some stringing but not so much to impede efficient application from a dispensing tube with a dropper tip. This composition is shown to restore corroded copper coupons as described previously. The resistance is measured at 50,000 ohms and when applied to the electrical connections for trailer and a vehicle, the electrical connection works efficiently. Once disconnected, residual protective gel can be easily removed by rinsing with water if desired. However, the increased electrical conductivity of example two makes it preferred.

### EXAMPLE FIVE

A protective gel of the following composition is provided:

| Component | Approximate Percent by Weight |
|---|---|
| Carboxymethylcellulose | 1.83 |
| All ® Small & Mighty ™ | 5.5 |
| Citrate (as Citric Acid) | 1.83 |
| Sodium Sulfite | 1.83 |
| Propylene Glycol | 56.7 |
| Distilled Water | 32.1 |

This composition is prepared as follows: Sixty two (62) grams glycerin is mixed with 35 grams of distilled water, six grams of All Small & Mighty™, two grams of sodium sulfite and two grams of citric acid. To this well mixed composition, 2 grams of CMC (12M31P, Hercules Incorporated, Wilmington Del.) is added and mixed vigorously. It is noted that hydration of the cellulose gum is particularly slow and some persistant foam is present from early addition and vigorous mixing of the surfactant. The mixture thickens slowly.

It is important to note that citrate (pKa=6.4) and sulfite (pKa=6.91) can act as desirable pH buffers in this system. The pH of the resulting composition is approximately 6.0 and the resulting gel is viscous and will flow slowly but readily and is easily applied from a dispensing tube with a dropper tip with moderate amounts of stringing. This composition is thus shown to restore corroded copper coupons as described previously and the resistance is measured at 1300 ohms. When applied to the electrical connections for a trailer and a vehicle, the electrical connection works efficiently. Once disconnected, residual protective gel can be easily removed by rinsing with water if desired. However, the decreased stringing of example two makes it preferred.

### EXAMPLE SIX

A protective gel of the following composition is provided:

| Component | Approximate Percent by Weight |
|---|---|
| Carboxymethylcellulose | 0.83 |
| Sodium Laurylsulfate | 1.24 |
| Citrate (as Citric Acid) | 4.13 |
| Sodium Sulfite | 4.13 |
| Propylene Glycol | 43.0 |
| Bromothymol Blue | 0.0021 |
| Potassium Sorbate | 0.83 |
| Sodium Bicarbonate | 8.27 |
| SodiumHydroxide | 4.3 |
| Distilled Water | 41.5 |

This composition is prepared as follows: To 50 grams of distilled water, five grams of sodium sulfite, one gram of potassium sorbate, five grams of citric acid, 1.5 grams of sodium laurylsulfate and one gram of CMC (9H4F, Hercules Incorporated, Wilmington Del.) are added with constant, vigourous mixing. The agitation is moderated and 52 grams of propylene glycol are added along with 0.0025 grams of bromothymol blue (as 0.25 ml of 1% bromothymol blue in distilled water). It is noted that hydration of the cellulose gum is particularly slow and some persistant foam is present from early addition and vigorous mixing of the surfactant and bicarbonate. The pH of the resulting composition is adjusted with ten grams of sodium bicarbonate and 5.2 grams of sodium hydroxide to a pH of approximately 10 causing the bromothymol blue to change in color from yellow to dark blue. The mixture thickens slowly.

It is important to note that sodium bicarbonate/sodium carbonate (pKa=10.25) can act as a desirable pH buffer in this system. The resulting composition is moderately viscous and will flow slowly but readily and is easily applied from a dispensing tube with a dropper tip with little stringing. This composition is thus shown to restore corroded copper coupons as described previously and the resistance is measured at 20,000 ohms. When applied to the electrical connections for trailer and a vehicle, the electrical connection works efficiently. Once disconnected, residual protective gel can be easily removed by rinsing with water if desired. However, the increased firmness of the gel of example two makes it preferred.

This application—taken as a whole with the abstract, specification, claims, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure.

Because of this disclosure and solely because of this disclosure, modification of this tool can become clear to a person having ordinary skill in this particular art. Such modifications are clearly covered by this disclosure.

What is claimed and sought to be protected by Letters Patent is:

1. A protective gel for an electrical connection comprising:
a) the protective gel being water soluble; and
b) the protective gel having a thickening agent, a cleaning agent, a chelating agent, a reducing agent, anti-corrosive agent, a buffer, and an antifreeze agent.

2. The protective gel of claim 1 further comprising:
a) the thickening agent being up to about 8 percent by weight of the protective gel;
b) the cleaning agent being up to to about 20 percent by weight of the protective gel;
c) the chelating agent being up to about 8 percent by weight of the protective gel;
d) the anti-corrosive agent being up to about 20 percent by weight of the protective gel;
e) the buffer being up to about 20 percent by weight of the protective gel; and
f) the antifreeze agent being about 20 percent to about 80 percent by weight of the protective gel.

3. The protective gel of claim 2 further comprising:
a) the thickening agent being at least one thickening agent selected from the group consisting of carboxymethylcellulose, carbomer, methylcellulose, hydroxyethylcellulose, hydroxypropylcellulose, guar gum, alginate, pectin, gelatin, xanthangum, and polyvinylalcohol;
b) the cleaning agent being at least one cleaning agent selected from the group consisting of at least one ionic surfactant and at least one non-ionic surfactant;
c) the chelating agent being at least one chelating agent selected from the group consisting of at least one metal citrate, at least one metal tartrate, at least one metal propionate, and at least one amino substituted carboxylic acid;
d) the anti-corrosive agent being at least one anti-corrosive agent selected from the group consisting of at least one metal sulfite, at least one metal phosphite, at least one metal hypophosphite, a borohydride, an aminoborane, and formaldehyde;
e) the buffer being at least one anti-corrosive agent selected from the group consisting of at least one metal bicarbonate; at least one metal carbonate, at least one metal phosphate, and at least one metal amine; and
f) the antifreeze agent being at least one antifreeze agent selected from the group consisting of at glycerin, propylene glycol and ethylene glycol.

4. The protective gel of claim 3 further comprising:
a) the thickening agent being about 0.5 to about 6 percent by weight of the protective gel;
b) the cleaning agent being about 0.5 to about 15 percent by weight of the protective gel;
c) the chelating agent being about 0.5 to about 6 percent by weight of the protective gel;
d) the anti-corrosive agent being about 0.5 to about 15 percent by weight of the protective gel;
e) the buffer being about 0.5 to about 15 percent by weight of the protective gel;
f) the antifreeze agent being about 25 to about 75 percent by weight of the protective gel; and
g) the balance being water.

5. The protective gel of claim 4 further comprising the protective gel having a resistant between 1000 and 300,000 ohms.

6. The protective gel of claim 2 further comprising;
a) the thickening agent being about 0.5 to about 6 percent by weight of the protective gel;
b) the cleaning agent being up to to about 20 percent by weight of the protective gel;
c) the chelating agent being about 0.5 to about 6 percent by weight of the protective gel;
d) the anti-corrosive agent being about 0.5 to about 15 percent by weight of the protective gel;
e) the buffer being about 0.5 to about 15 percent by weight of the protective gel;
f) the antifreeze agent being about 30 to about 60 percent by weight of the protective gel; and
g) the balance being water.

7. The protective gel of claim 3 further comprising;
a) the thickening agent being carboxymethylcellulose and about 0.5 to about 5 percent by weight of the protective gel;
b) the cleaning agent being sodium laurylsulfate and about 0.5 to about 25 percent by weight of the protective gel;
c) the chelating agent being sodium citrate and about 0.5 to about 6 percent by weight of the protective gel;
d) the anti-corrosive agent being sodium sulfite and about 0.5 to about 8 percent by weight of the protective gel;
e) the buffer being sodium bicarbonate and about 0.5 to about three percent by weight of the protective gel; and
f) the antifreeze agent being glycerin and about 20 to about 70 percent of the protective gel.

8. The protective gel of claim 7 further comprising:
a) the thickening agent being about 0.5 to about 3 percent; and
b) the cleaning agent being about 0.5 to about 3 percent;
c) the chelating agent being about 0.5 to about 4 percent;
d) the anti-corrosive agent being about one to about six percent;
e) the buffer being about 0.5 to about three percent; and
f) the antifreeze agent being about 30 to about 60 percent.

9. The protective gel of claim 8 further comprising:
a) the thickening agent being about 0.5 to about one percent;
b) the cleaning agent being about 0.5 to about one percent;
c) the chelating agent being about one to about two percent;
d) the anti-corrosive agent being about two to about four percent;
e) the buffer being about 0.5 to about one percent; and
f) the antifreeze agent being about 40 to about 50 percent.

10. The protective gel of claim 6 further comprising:
a) the thickening agent further including at least one polyvalent cation; and
b) the resistance of the protective being about 1000 to about 50,000 ohms.

11. The protective gel of claim 10 further comprising:
a) the preferred cleaning agent being an ionic surfactant or a non-ionic surfactants; and
b) the chelating agent being at least one chelating agent selected from the group consisting of sodium tartrate, sodium propionate, and ethylenediamine tetraacetic acid.

12. A method of protecting a vehicle connection and a trailer connection so that a proper electrical connection between the trailer lights and the vehicle lights can be obtained comprising:
a) providing a water soluble protective gel having a thickening agent, a cleaning agent, a chelating agent, a reducing agent, anti-corrosive agent, a buffer, and an antifreeze agent;
b) applying the water soluble protective gel to the vehicle connection and the trailer connection; and
c) cleaning the vehicle connection and the trailer connection.

13. The method of claim 12 further comprising:
a) maintaining the vehicle connection and the trailer connection in a clean condition;
b) restoring the vehicle connection and the trailer connection in a clean condition from a corroded condition with the chelating agent and the reducing agent; and
c) providing a viscosity for the water soluble protective gel viscosity to be sufficiently high and prevent free flowing from the terminals while being sufficiently low to allow dispensing using a flexible metal or plastic tube fitted with a dropper.

14. A protective gel for an electrical connection comprising:
a) the protective gel being water soluble;
b) the protective gel having a thickening agent, a cleaning agent, a chelating agent, a reducing agent, anti-corrosive agent, a buffer, and an antifreeze agent; and
c) the protective gel having a resistance is between 1000 and 50,000 ohms.

15. The protective gel of claim 14 further comprising:
a) the protective gel having as the thickening agent about 2.1 percent by weight carboxymethylcellulose;
b) the protective gel having as the cleaning agent about 2.1 percent by weight sodium laurylsulfate;
c) the protective gel having as the chelating agent about 3.2 percent by weight citric acid;
d) the protective gel having as the chemically reducing agent about 3.2 percent by weight sodium sulfite;
e) the protective gel having as the anti freeze agent about 53 percent by weight propylene glycol;
f) the protective gel having as a pH agent about 1.6 percent by weight sodium hydroxide;
g) the protective gel having about 0.0027 percent by weight Phenol Red as pH indicator;
h) the protective gel having as a preservative about 0.27 percent by weight potassium sorbate; and
i) the balance distilled water.

16. The protective gel of claim 14 further comprising:
a) the protective gel having as the thickening agent about 0.95 percent by weight carboxymethylcellulose;
b) the protective gel having as the cleaning agent about 0.95 percent by weight sodium laurylsulfate;
c) the protective gel having as the chelating agent about 0.95 percent by weight citric acid;
d) the protective gel having as the chemically reducing agent about 0.95 percent by weight sodium phosphite;
e) the protective gel having as the anti freeze agent about 47.5 percent by weight glycerin;
f) the protective gel having as a pH agent about 4.75 percent by weight triethanol aminesodium hydroxide;
g) the protective gel having about 0.0027 percent by weight Bromothymol Blue as pH indicator;
h) the protective gel having as a preservative about 0.09 percent by weight potassium sorbate; and
i) the balance distilled water.

17. The protective gel of claim 14 further comprising:
a) the protective gel having as the thickening agent about 0.89 percent by weight carbomer;
b) the protective gel having as the cleaning agent about 2.1 percent by weight polysorbate;
c) the protective gel having as the chelating agent about 0.22 percent by weight citric acid;
d) the protective gel having as the chemically reducing agent about 0.22 percent by weight sodium sulfite;
e) the protective gel having as the anti freeze agent about 35.8 percent by weight propylene glycol;
f) the protective gel having as a pH agent about 10.7 percent by weight triethanol amine;
g) the protective gel having about 0.0022 percent by weight Bromothymol Blue as pH indicator;
h) the protective gel having as a preservative about 0.09 percent by weight potassium sorbate; and
i) the balance distilled water.

18. The protective gel of claim 14 further comprising:
a) the protective gel having as the thickening agent about 1.83 percent by weight carboxymethylcellulose;
b) the protective gel having as the cleaning agent about 5.51 percent by weight laundry detergent;
c) the protective gel having as the chelating agent about 1.83 percent by weight citric acid;
d) the protective gel having as the chemically reducing agent about 1.83 percent by weight sodium sulfite;
e) the protective gel having as the anti freeze agent about 56.7 percent by weight propylene glycol; and
f) the balance distilled water.

19. The protective gel of claim 14 further comprising:
a) the protective gel having as the thickening agent about 0.83 percent by weight Carboxymethylcellulose;
b) the protective gel having as the cleaning agent about 1.24 percent by weight sodium laurylsulfate;
c) the protective gel having as the chelating agent about 4.13 percent by weight citric acid;
d) the protective gel having as the chemically reducing agent about 4.13 percent by weight sodium sulfite;
e) the protective gel having as the anti freeze agent about 43.0 percent by weight propylene glycol;
f) the protective gel having as a pH agent about 4.3 percent by weight sodium hydroxide;
g) the protective gel having about 0.0021 percent by weight Bromothymol Blue as pH indicator;
h) the protective gel having about 8.27 percent by weight sodium bicarbonate as a buffer;
i) the protective gel having as a preservative about 0.83 percent by weight potassium sorbate; and
j) the balance distilled water.

20. The protective gel of claim 14 further comprising:
a) the thickening agent being up to about 8 percent by weight of the protective gel;
b) the cleaning agent being up to about 20 percent by weight of the protective gel;
c) the chelating agent being up to about 8 percent by weight of the protective gel;
d) the anti-corrosive agent being up to about 20 percent by weight of the protective gel;
e) the buffer being up to about 20 percent by weight of the protective gel;
f) the antifreeze agent being about 30 percent to about 80 percent by weight of the protective gel;
g) the thickening agent being at least one thickening agent selected from the group consisting of carboxymethylcellulose, carbomer, methylcellulose, hydroxyethylcellulose, hydroxypropylcellulose, guar gum, alginate, pectin, gelatin, xanthangum, and polyvinylalcohol;
h) the cleaning agent being at least one cleaning agent selected from the group consisting of at least one ionic surfactant and at least one non-ionic surfactant;
i) the chelating agent being at least one chelating agent selected from the group consisting of at least one metal citrate, at least one metal tartrate, at least one metal propionate, and at least one amino substituted carboxylic acid;
j) the anti-corrosive agent being at least one anti-corrosive agent selected from the group consisting of at least one metal sulfite, at least one metal phosphite, at least one metal hypophosphite, a borohydride, an aminoborane, and formaldehyde;
k) the buffer being at least one anti-corrosive agent selected from the group consisting of at least one metal bicarbonate; at least one metal carbonate, at least one metal phosphate, and at least one metal amine;
l) the antifreeze agent being at least one antifreeze agent selected from the group consisting of at glycerin, propylene glycol and ethylene glycol; and
m) the protective gel having a resistance of from about 1000 to about 20,000 ohms.
